(19) United States
(12) Patent Application Publication
(10) Pub. No.: US 2006/0168387 A1
(43) Pub. Date: Jul. 27, 2006

(54) [CRAD READER WITH PCI EXPRESS]

(75) Inventors: WEE-KUAN GAN, TAIPEI (TW); JIUNN-YEONG YANG, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., HSINCHU HSIEN (TW)

(21) Appl. No.: 10/905,900

(22) Filed: Jan. 26, 2005

(51) Int. Cl. G06F 13/14

(52) U.S. Cl. 710/305

(57) ABSTRACT

A card reader with PCI Express includes a microcontroller connected separately to a flash memory connecting interface and a peripheral component interconnect (PCI) Express connecting interface, and the microcontroller has a memory card interface and a PCI Express interface, such that when the memory card is coupled to a PCI Express disposed at a host through the PCI Express connecting interface, the host can access data in the memory card connected to the memory card connecting interface and the access rate can meet the standard of the transmission rate of the PCI Express so as to maximize the transmission rate of the card reader.

### BACKGROUND OF THE INVENTION

1. Field of the Invention

The present invention relates to a card reader with a peripheral component interconnect express (PCI Express), and more particularly to a card reader that uses the PCI Express as a transmission interface.

2. 2. Description of the Related Art

As the science and technology of computers grows in a fast changing manner, a computer tends to be developed with powerful computational functions and a fast speed, and thus the clock of a central processing unit (CPU) is too fast, and the transmission rate of other peripheral equipments cannot catch up with the processing speed of the CPU at all. Even though the CPU continues enhancing its performance, the transmission rate of peripheral equipments cannot be improved much because the overall performance of a computer depends on the whole system. It is necessary to improve the whole computer architecture before the performance of a CPU can be maximized.

However, the data transmission rate depends on the transmission rate of a bus. To enhance the performance of a computer, related manufacturers usually improve the transmission rate of a bus. For example, the transmission rate of an integrated drive electronic (IDE) interface connected to a hard disk drive reaches 160 MB/s; the network line is upgraded from 10 MB/s to 1 GB/s; the transmission rate of the RS-232 is replaced by the 480 MB/s of the universal serial bus (USB), and the present PCI with a transmission rate of 133 MB/s upgrades the transmission rate of its lane to 250 MB/s which is know as a new-generation peripheral component interconnect express (PCI Express). The PCI Express further supports a hot-plug control function. Therefore, the PCI Express is extensively accepted by users.

Further, The flash memory since its announcement gradually replaces the EEPROM or battery power memory in many portable device due to its charming features including low power consumption, non-volatility, shock resistance, and high-capacity storage. With the advanced semiconductor technologies, the storage capacity and transmission rate of a flash memory grow rapidly. The flash memory replaces traditional storage medium such as a hard disk drive in many applications; however, the present memory card made of flash memories has become an indispensable product to the general public due to the popularity of electric products such as digital cameras, PDAs and mobile phones, etc. The sales volume and the type of memory cards are growing, and most memory cards use a universal serial bus (USB) or integrated drive electronics (IDE) interface as the transmission interface. The transmission rates of the USB and IDE interface are just 480 MB/s and 160 MB/s respectively, and such transmission rate cannot catch up with the accessing speed of the memory card, so that the application of memory cards is restricted by the USB or IDE interface of the host and its performance cannot be maximized.

Therefore, it is desirable to provide a card reader that eliminates the aforesaid drawbacks.

### SUMMARY OF THE INVENTION

The present invention has been accomplished under the circumstances in view. Therefore, it is a primary objective of the present invention to use the PCI Express bus as a transmission interface between a host and a card reader, so that the maximum transmission rate can be achieved when the host accesses data in the memory card through the card reader.

According to the foregoing objective, the card reader includes a microcontroller, and the microcontroller is coupled separately to a memory card interface for connecting a memory card and a PCI Express bus interface for connecting a PCI Express bus of a host, and the microcontroller has a memory card interface and a PCI Express bus interface, such that when the host saves or reads data in a memory card connected to the memory card interface, the memory card interface and PCI Express bus interface of the microcontroller converts the data into a data format acceptable to the memory card or the PCI Express bus, and then sends the converted data to the host or the memory card so as to meet the standard of the transmission rate of the PCI Express bus when the host accesses data in the storage device, and the transmission rate of the storage device can be maximized.

### BRIEF DESCRIPTION OF THE DRAWINGS

FIG. 1 is a block diagram according to a preferred embodiment of the present invention.

FIG. 2 is a schematic diagram of a data transmission according to a preferred embodiment of the present invention.

### DETAILED DESCRIPTION OF THE PREFERRED EMBODIMENT

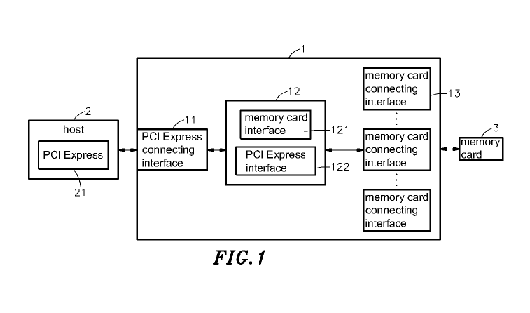

Referring to FIGS. 1, a card reader 1 comprises a peripheral component interconnect express (PCI Express) connecting interface 11, a microcontroller 12 and a memory card connecting interface 13.

The PCI Express connecting interface 11 is connected to a PCI Express 21 installed in a host 2.

The microcontroller 12 includes a memory card interface 121 and a PCI Express interface 122, and the microcontroller 12 is connected to the PCI Express connecting interface 11.

A memory card 13 is connected to the microcontroller 12, and the memory card interface 13 is provided for connecting the memory card 3.

If the PCI Express connecting interface 11 of the card reader 1 is connected to the PCI Express 21 of the host 2, then the microcontroller 12 of the card reader 1 will declare the memory card 1 as an endpoint device to the host 2. When the memory card 3 is connected to the memory card connecting interface 13, the host 2 can access data in the memory card 3.

When the host 2 transmits data to the memory card 3, the data in the host 2 is transmitted to the microcontroller 12 through the PCI Express 21 and the PCI Express connecting interface 11, and the memory card interface 121 of the microcontroller 12 converts the data into a data format acceptable to the memory card 3 and then save the data into the memory card 3 through the memory card connecting interface 13.

Further, if the host 2 intends to read data in the memory card 3, the memory card 3 will send the data to the micorcontroller 12 through the memory card connecting interface 13 first and the PCI Express interface 122 of the microcontroller 12 will convert the data into a data format acceptable to the PCI Express 21 and send the data to the host 2 through the PCI Express connecting interface 11 and the PCI Express 21.

The memory card interface 121 could be a CF memory card interface, a MS memory card interface, an XD memory card interface or a SD card interface. The quantity of memory card connecting interface 13 could be one or more.

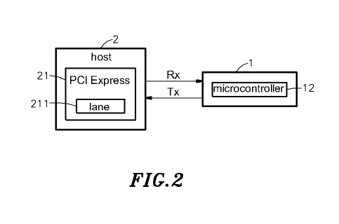

Reference is made to FIG. 2, the host 2 and the card reader 1 has a lane 211 at a physical layer for transmitting data, and the lane 211 comprises a transmitting end Tx and a receiving end Rx, and the quantity of the lane 211 could be one or more.

Therefore, the key technology for the card reader with PCI Express in accordance with the present invention to overcome the shortcoming of the prior arts resides on that the invention adopts the PCI Express as the interface between the host and the card reader, such that when the memory card connected to the card reader accesses data, the transmission rate can meet the standard of the PCI Express and thus the transmission rate of the card reader can be maximized.

A prototype of card reader with PCI Express has been constructed with the features of FIGS. 1˜2. The card reader with PCI Express functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A card reader with PCI Express, comprising: a microcontroller, including a memory card interface capable of converting a data into a memory card format and a PCI Express interface capable of converting a data into a PCI Express format;
a memory card connecting interface, being coupled to said microcontroller and provided for connecting a memory card;
a PCI Express connecting interface, for coupling a PCI Express of a host and coupling said microcontroller;
thereby if said host saves or read data in said memory card coupled to said memory card connecting interface, said memory card interface and said PCI Express interface of said microcontroller will convert said data into a data format acceptable to said memory card or PCI Express and then send said data to said host or said memory card, such that said host is capable of accessing data in said memory card through said PCI Express connecting interface.

2. The card reader as claimed in claim 1, wherein said host and said card reader include a lane disposed at a physical layer for transmitting data, and said lane comprises a transmitting end (Tx) and a receiving end (Rx).

3. The card reader as claimed in claim 2, wherein said lane has a quantity of one or more.

4. The card reader as claimed in claim 1, wherein said memory card connecting interface has a quantity of one or more.

5. The card reader as claimed in claim 1, wherein said memory card interface is a CF memory card interface.

6. The card reader as claimed in claim 1, wherein said memory card interface is a MS memory card interface.

7. The card reader as claimed in claim 1, wherein said memory card interface is an XD memory card interface.

8. The card reader as claimed in claim 1, wherein said memory card interface is a SD memory card interface.
